(19) United States
(12) Patent Application Publication
(10) Pub. No.: US 2025/0250366 A1
(43) Pub. Date: Aug. 7, 2025

(54) METHOD OF DESULFURIZING SULFUR-CROSSLINKED RUBBER

(71) Applicants: TOYODA GOSEI CO., LTD., Kiyosu-shi (JP); National University Corporation Tokai National Higher Education and Research System, Nagoya-shi (JP)

(72) Inventors: Akishige SEO, Kiyosu-shi (JP); Tatsuya AO, Kiyosu-shi (JP); Toshiaki MURAI, Gifu-shi (JP)

(21) Appl. No.: 19/022,319

(22) Filed: Jan. 15, 2025

(30) Foreign Application Priority Data
Feb. 1, 2024 (JP) 2024-014220

(51) Int. Cl. C08C 19/30

(52) U.S. Cl. CPC C08C 19/30

(57) ABSTRACT

A method of desulfurizing sulfur-crosslinked rubber includes adding at least one selected from the group consisting of primary and secondary phosphine oxides and analogues of the primary and secondary phosphine oxides, primary and secondary phosphines which become oxides when oxidized and analogues of the primary and secondary phosphines, sulfenic acid, and sulfinic acid as a desulfurizing agent that acts on a sulfur bond in the sulfur-crosslinked rubber and cleaves the sulfur bond to the sulfur-crosslinked rubber, and performing heating.

### TECHNICAL FIELD

The present invention relates to a method of desulfurizing sulfur-crosslinked rubber.

### BACKGROUND ART

As a method of desulfurizing sulfur-crosslinked rubber (particularly, a method of desulfurizing used sulfur-crosslinked rubber to make it reusable recycled desulfurized rubber), currently, a method of performing physical desulfurizing when sulfur-crosslinked rubber is melted and kneaded to form a highly sheared flow field (shear desulfurization) is general.

Patent Literature 1 describes a method in which sulfur-crosslinked rubber containing carbon black is pulverized, put into a twin screw extruder, and desulfurized by applying a shear stress of 10 kg/cm² to 150 kg/cm² while heating to a temperature of 180° C. to 350° C., and recycled desulfurized rubber with cleaved sulfur-crosslinked bonds is produced. In addition, it also describes that a desulfurizing agent is used in combination therewith for shear desulfurization.

However, the problem with shear desulfurization is deterioration in physical properties (low selectivity) due to cleavage of the rubber main chain (other than S—S, and C—S bonds), and it is currently difficult to return recycled desulfurized rubber to the same state as new raw rubber. In addition, desulfurization occurs under high temperature conditions.

On the other hand, in the method in which a sulfur bond in the structure of sulfur-crosslinked rubber is chemically cleaved using a desulfurizing agent (regenerating agent) for desulfurization (chemical desulfurization), since the sulfur bond is selectively cleaved, cleavage of the main chain is less likely to occur. Therefore, the same molecular weight as that of new raw rubber can be maintained for recycled desulfurized rubber produced by chemical desulfurization, for which deterioration of physical properties can be reduced. In addition, desulfurization can be performed under mild conditions.

Examples of desulfurizing agents include disulfide compounds (R—S—S—R), thiol compounds (R—SH), dimethyl sulfoxide (DMSO), and amine compounds (NR₃). The desulfurizing agents described in Patent Literature 1 include diaryl disulfide, dihexyl disulfide, and thiophenol-iron oxide. In addition, the desulfurizing agent described in Patent Literature 2 includes phenyl-hydrazine-iron chloride, triphenylphosphine, thiols, and disulfides. In addition, the desulfurizing agent described in Patent Literature 3 includes amine compounds (octylamine, hexadecylamine, dioctylamine, trioctylamine, benzylamine, or 4-piperidinopiperidine).

However, since all of these desulfurizing agents are a group of compounds that emit a unique odor, the odor generated during desulfurization causes a physical burden on operators, and the recycled rubber after desulfurization also has an odor, which makes it difficult to use as a recycled material.

### CITATION LIST

### Patent Literature

[Patent Literature 1] Japanese Unexamined Patent Application Publication No. H9-227724 (JP H9-227724 A)
[Patent Literature 2] Japanese Unexamined Patent Application Publication (Translation of PCT Application) No. 2010-535912 (JP 2010-535912 A)
[Patent Literature 3] Japanese Unexamined Patent Application Publication (Translation of PCT Application) No. 2003-510437 (JP 2003-510437 A)

### SUMMARY OF THE INVENTION

### Technical Problem

Therefore, an object of the present invention is to desulfurize sulfur-crosslinked rubber while reducing deterioration in physical properties and reducing an odor during desulfurization and after desulfurization.

### Solution to Problem

[1] A method of desulfurizing sulfur-crosslinked rubber, including
adding at least one selected from the group consisting of primary and secondary phosphine oxides and analogues of the primary and secondary phosphine oxides, primary and secondary phosphines which become oxides when oxidized and analogues of the primary and secondary phosphines, sulfenic acid, and sulfinic acid as a desulfurizing agent that acts on a sulfur bond in the sulfur-crosslinked rubber and cleaves the sulfur bond to the sulfur-crosslinked rubber, and performing heating.

[2] The method of desulfurizing sulfur-crosslinked rubber according to [1],
wherein a radical initiator that allows a radical for generating a radical active species from the desulfurizing agent to be generated is also added to the sulfur-crosslinked rubber.

[3] The method of desulfurizing sulfur-crosslinked rubber according to [1],
wherein no radical initiator that allows a radical for generating a radical active species from the desulfurizing agent to be generated is added to the sulfur-crosslinked rubber.

[4] The method of desulfurizing sulfur-crosslinked rubber according to any one of [1] to [3],
wherein a solvent is also added to the sulfur-crosslinked rubber.

[5] The method of desulfurizing sulfur-crosslinked rubber according to any one of [1] to [3],
wherein no solvent is added to the sulfur-crosslinked rubber.

[6] The method of desulfurizing sulfur-crosslinked rubber according to any one of [1] to [5],
wherein the heating is performed while kneading in a kneading extruder.

### <Inference of Mechanism of Desulfurization Reaction in Present Invention>

Secondary phosphine oxides, which can be expressed as R1R2HP═O (R1 and R2 are not particularly limited), are in a chemical equilibrium state such as R1R2HP=0<=>R1R2P—OH, and desulfurization finally occurs when particularly R1R2P—OH reacts nucleophilically with sulfur in sulfur-crosslinked rubber.
A similar reaction mechanism also occurs with primary phosphine oxides. However, a similar reaction does not progress with tertiary phosphine oxides.
A similar reaction mechanism also occurs with sulfenic acid (RSOH) and sulfinic acid (RS(O) OH).

For more details using the example of diphenylphosphine oxide (DPPO), the inference shown in the following chemical formula 1 is made.

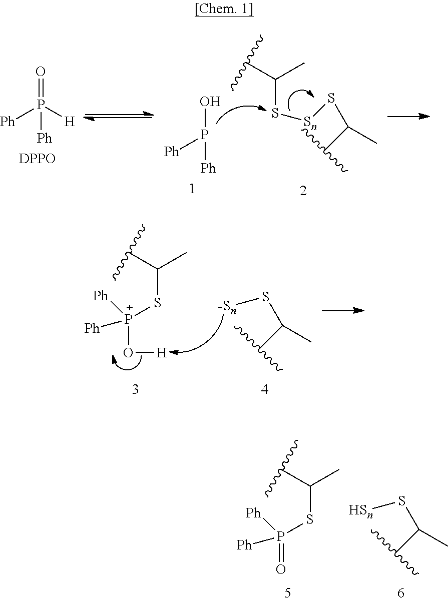

DPPO is in a chemical equilibrium state with Compound 1 (the bias is toward DPPO). Compound 1 attacks sulfur in sulfur-crosslinked rubber, S—S bonds are cleaved, and Compounds 3 and 4 are formed. Here, negatively charged sulfur in Compound 4 receives the proton from Compound 3 to form Compounds 5 and 6. Desulfurization progresses through a similar process.

Since a desulfurizing agent in the present invention selectively reacts with a sulfur bond in the rubber and cleaves the sulfur bond, even when desulfurization progresses, cleavage of the main chain of the rubber is less likely to occur, and it is possible to reduce deterioration in physical properties.

In addition, the desulfurizing agent in the present invention generates almost no or little odor compared to the desulfurizing agents listed in the section of the related art and thus an odor generated during desulfurization is reduced and an odor is less likely to remain in the rubber after desulfurization.

<With or without Radical Initiator>

In the present invention, desulfurization progresses regardless of whether a radical initiator is added, but when a radical initiator is added, desulfurization may further progress. This is because the desulfurizing agent used in the present invention is also a radical precursor that generates a radical active species that acts on a sulfur bond in the sulfur-crosslinked rubber and cleaves the sulfur bond, and the mechanism of the desulfurization reaction inferred as follows may also be involved.
1) Radicals are generated from a radical initiator by heating.
2) The generated radicals react with a radical precursor, and the radical precursor generates a radical active species.
3) The radical active species reacts with a sulfur bond in sulfur-crosslinked rubber to generate a radical intermediate.
4) The radical active species generated in 2) and the radical intermediate in 3) further react to cleave the sulfur bond.
5) Desulfurization of the sulfur-crosslinked rubber progresses while repeating 1)-4).

For more details using the example of DPPO and 2,2′-azobis(isobutyronitrile) (AIBN), the inference shown in the following chemical formula 2 is made.

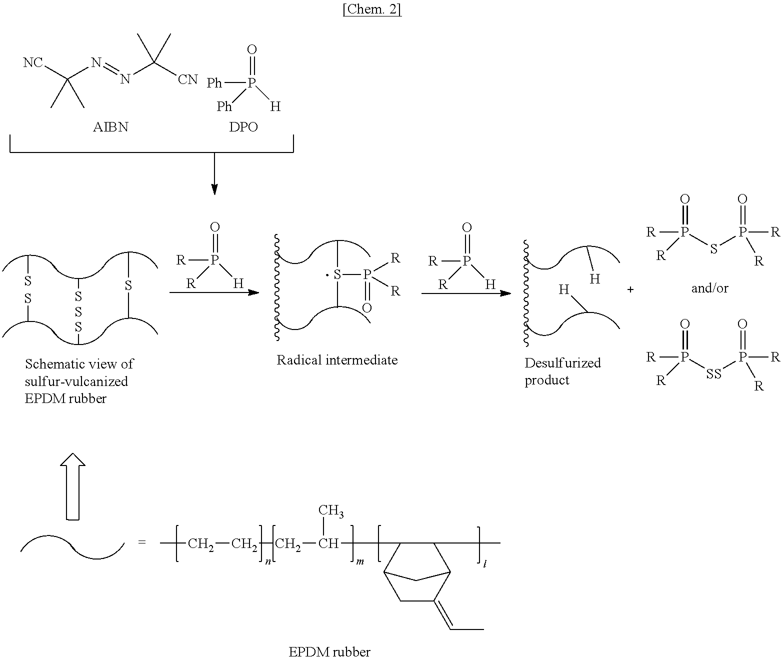

1) Two C—N double bonds near the center of AIBN are cleaved by heating, and nitrogen gas and 2-cyano-2-propyl radicals are generated.
2) The generated propyl radicals react with H of a phosphorus-centered radical precursor, and the radicals are transferred onto phosphorus atoms to generate phosphine oxide radicals.
3) The phosphine oxide radicals react with a sulfur bond in the sulfur-crosslinked rubber to generate a radical intermediate.
4) The phosphine oxide radicals generated in 2) additionally react with the radical intermediate in 3) to cleave the sulfur bond.
5) Desulfurization of the sulfur-crosslinked rubber progresses while repeating 1) to 4).

However, since many radical initiators, such as AIBN, are self-reactive and should be handled carefully, it is preferable not to add a radical initiator in consideration of handling properties.

<With or without Solvent>

It has been found that the desulfurization reaction in the present invention progresses regardless of whether or not a solvent is added.
(a) When a solvent is added, the solvent swells sulfur-crosslinked rubber and liquefies the desulfurizing agent to form a reaction field.
(b) When no solvent is added, the desulfurizing agent liquefies in the heated reaction system and functions as a reaction field (substitute for the solvent). Therefore, it is preferable to add the desulfurizing agent in an appropriate addition amount (concentration) suitable for forming a reaction field. When the addition amount is too small (low concentration), the liquid component is thin, it is difficult to form a reaction field, and the stirring efficiency is poor, and when the addition amount is too large (high concentration), the reaction system is diluted. An appropriate addition amount of the desulfurizing agent when no solvent is added varies depending on the rubber type, and is not particularly limited, and may be, for example, 1 equivalent to 20 equivalents per 1 g of the rubber, and is preferably 5 equivalents to 20 equivalents, and more preferably 8 equivalents to 15 equivalents.

However, not adding a solvent provides the following effects that are difficult to obtain when a solvent is added.
(1) The heating can be performed while kneading, for example, in a kneading extruder, which is practical.
(2) There is no need to dry the rubber after the reaction, and a post-treatment can be simplified.
(3) The environmental load can be reduced.

Therefore, when these effects are important, it is preferable not to add a solvent.

### Advantageous Effects of Invention

According to the present invention, it is possible to desulfurize sulfur-crosslinked rubber while reducing deterioration in physical properties and reducing an odor during desulfurization and after desulfurization.

### BRIEF DESCRIPTION OF DRAWINGS

FIG. 1 is a graph plotting the amount of a desulfurizing agent added and the degree of swelling in Samples 4, 5, and 7, which correspond to examples of the present invention.

### DESCRIPTION OF EMBODIMENTS

### <1>Sulfur-Crosslinked Rubber

The rubber types of sulfur-crosslinked rubber are not particularly limited, and examples thereof include ethylene propylene rubber (EPDM, EPM), natural rubber (NR), isoprene rubber (IR), butyl rubber (IIR), butadiene rubber (BR), styrene butadiene rubber (SBR), chloroprene rubber (CR), and nitrile rubber (NBR).

The sulfur-crosslinked rubber is preferably a pulverized product in the form of flakes, granules or the like that has been pulverized before desulfurization.

As the sulfur-crosslinked rubber, used rubber can be suitably used, and the usage time and usage conditions are not particularly limited. According to the present invention, used sulfur-crosslinked rubber can be desulfurized into recycled desulfurized rubber that can be reused.

### <2>Desulfurizing Agent

As described above, as the desulfurizing agent, at least one selected from the group consisting of primary and secondary phosphine oxides and analogues thereof (phosphite, etc.), primary and secondary phosphines which become oxides when oxidized and analogues thereof, sulfenic acid, and sulfinic acid is used.

Specific examples thereof include diphenylphosphine oxide (DPPO), di-p-tolylphosphine oxide, diadamantylphosphine, bis-3,5-dimethylphenylphosphine oxide, dicyclohexylphosphine oxide, di-4-methoxyphenylphosphine oxide, diphenylphosphine, and diethyl phosphite, which are shown in the following chemical formula 3.

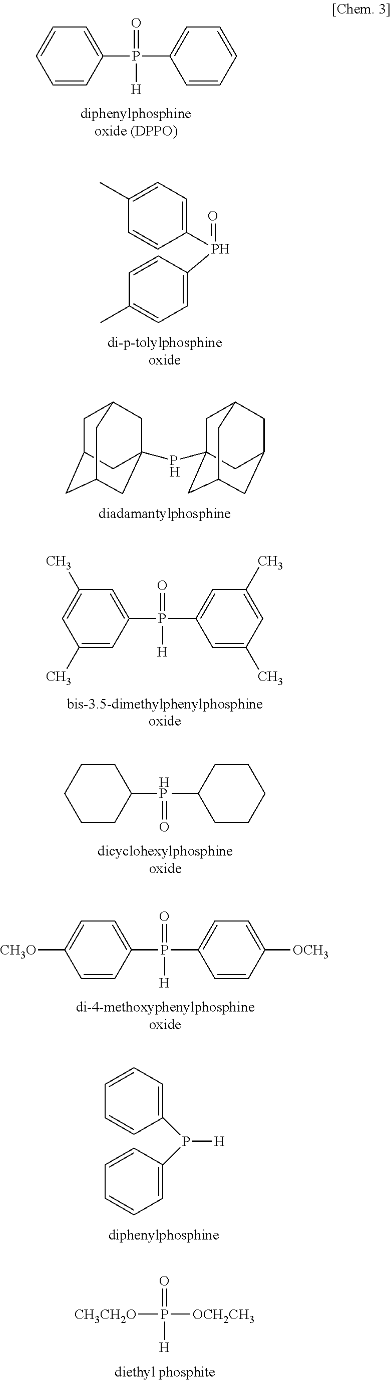

The amount of the desulfurizing agent added is not particularly limited because an appropriate addition amount varies depending on the rubber type, the heating temperature, the heating time and the like, and 0.5 equivalents to 25 equivalents per 1 g of the rubber may be exemplified, and 1 equivalent to 20 equivalents is preferable. In addition, an appropriate addition amount of the desulfurizing agent when no solvent is added is as described above.

### <3>Radical Initiator

The radical initiator is preferably at least one selected from the group consisting of azo compounds and peroxide compounds. This is because these compounds generate almost no or little odor, and are readily available.

The exemplified azo compounds include
2,2′-azobis(isobutyronitrile) (AIBN),
2,2′-azobis(4-methoxy-2,4-dimethylvaleronitrile),
2,2′-azobis(2,4-dimethylvaleronitrile),
1,1′-azobis(cyclohexane-1-carbonitrile),
2,2′-azobis(2-methylbutyronitrile),
1,1′-azobis(cyclohexane-1-carbonitrile), dimethyl
2,2′-azobis(isobutyrate), and 4,4′-azobis(4-cyanovaleric acid).

In addition, examples of peroxide compounds include di-tert-butyl peroxide, cumene hydroperoxide, dicumyl peroxide, and benzoyl peroxide (BPO).

The amount of the radical initiator added is not particularly limited because an appropriate addition amount varies depending on the rubber type, the heating temperature, the heating time and the like, and 0.5 equivalents to 16 equivalents per 1 g of the rubber may be exemplified and 1 equivalent to 8 equivalents is preferable.

### <4>Solvent

The solvents are not particularly limited, and the following solvents may be exemplified.
Non-polar solvent (benzene, toluene, xylene, etc.)
Low-polarity solvent (ortho-dichlorobenzene (o-DCB), 1-pentanol, chlorobenzene, etc.)·
High-polarity solvent (dimethylacetamide (DMA), dimethylsulfoxide (DMSO), etc.)·
Halogen-based solvent (tetrachloroethane, etc.)
Ether-based solvent (1,4-dioxane, etc.)

Particularly, it is preferable to use o-DCB and DMA in combination. This is because it significantly increases the desulfurization efficiency (Samples 21, 23, and 24 to be described below). The reason for this is unclear at present, but it is speculated to be due to some effects of a combination of a low-polarity solvent and a specific high-polarity solvent.

### <5>Heating Conditions

Heating is performed at a required temperature at which substantial progress of desulfurization is observed. The required temperature is not particularly limited because it varies depending on the rubber type, each of the addition amounts, the heating time and the like, and 60° C. to 200° C. may be exemplified, and the required temperature is preferably 110° C. or higher for EPDM rubber and is preferably 60° C. or higher for natural rubber.

The heating time is not particularly limited because an appropriate temperature varies depending on the rubber type, each of the addition amounts, the heating temperature and the like, and 1 hour to 24 hours may be exemplified.

It is preferable to perform stirring or kneading during heating. Whether to perform stirring or kneading can be appropriately selected depending on the state of materials.

### <6>Desulfurization Index

When rubber comes into contact with a solvent, it entraps the solvent and swells. This swelling also occurs in rubber before desulfurization, but the swelling rate determined by the following Formula 1 becomes higher as the rubber becomes further desulfurized. This is because the solvent enters where the sulfur bond is cleaved.

$$( Formula 1 )$$

$$swelling rate ( \% ) = ( swelled weight - dry weight ) / dry weight \times 100$$

Here, in the present invention, rubber before desulfurization (dry weight 1 g) is immersed in toluene as a solvent at room temperature for 24 hours, and the swelled weight is then measured to determine a swelling rate of rubber before desulfurization. In addition, rubber after desulfurization (dry weight 1 g) is immersed in the same solvent for the same time, and the swelled weight is then measured to determine a swelling rate of rubber after desulfurization. Then, the rate of increase in swelling rate determined by the following Formula 2 is used as a desulfurization index.

$$( Formula 2 )$$

$$rate of increase in swelling rate = swelling rate of rubber after desulfurization / swelling rate of rubber before desulfurization$$

However, since ease of swelling differs depending on the rubber type, it is difficult to uniformly evaluate the degree of desulfurization of various rubbers using the rate of increase in swelling rate, and there is a preferable rate of increase for each rubber type.

For example, the rate of increase in swelling rate in EPDM rubber is preferably 1.10 or more (substantial progress of desulfurization is considered to be observed), more preferably 1.30 or more, still more preferably 1.50 or more, and most preferably 2.00 or more.

In addition, the rate of increase in swelling rate in natural rubber is preferably 1.60 or more (substantial progress of desulfurization is considered to be observed), more preferably 2.00 or more, still more preferably 2.50 or more, and most preferably 3.00 or more.

### EXAMPLES

Next, examples of the present invention will be described. Here, materials, conditions, structures, shapes and sizes of examples are only examples, and can be appropriately changed without departing from the spirit and scope of the invention.

### Experiment 1

As a desulfurizaton experiment for sulfur-crosslinked EPDM rubber, Samples 1 to 26 shown in Tables 1 to 3 were performed.

TABLE 1

| | | Note | | | | | | |
|---|---|---|---|---|---|---|---|---|
| | | Before | With initiator, | | Different amounts of desulfurizing agent, | | | |
| | | desulfurization | with solvent | | with initiator, without solvent | | | |
| Sample No. | | 1 | 2 | 3 | 4 | 5 | 6 | 7 |
| Rubber | Type | EPDM | EPDM | EPDM | EPDM | EPDM | EPDM | EPDM |
| | Shape | Pulverized | Pulverized | Pulverized | Pulverized | Pulverized | Pulverized | Pulverized |
| Desulfurizing | Type | — | DPPO | DPPO | DPPO | DPPO | DPPO | DPPO |
| agent | Amount [eq] | — | 4 | 5 | 20 | 10 | 10 | 5 |
| Initiator | Amount [eq] | — | 2 | 2.5 | 20 | 10 | 5 | 2.5 |
| AIBN | | | | | | | | |
| Solvent | Type | — | o-DCB | o-DCB | — | — | — | — |
| | Amount [mL] | — | 12 | 5 | — | — | — | — |
| Reaction | Temperature (° C.) | — | 160 | 160 | 160 | 160 | 160 | 160 |
| conditions | Time [h] | — | 5 | 5 | 5 | 5 | 5 | 5 |
| Properties | Swelling rate [%] | 190 | 421 | 849 | 385 | 563 | 397 | 387 |
| | Rate of increase | | 2.216 | 4.468 | 2.026 | 2.963 | 2.089 | 2.037 |
| | to Sample 1 | | | | | | | |

| | | Note | | | | |
|---|---|---|---|---|---|---|
| | | Without solvent, | | | Different types of desulfurizing agent, | |
| | | different temperatures | | | without solvent | |
| Sample No. | | 8 | 9 | 10 | 11 | 12 |
| Rubber | Type | EPDM | EPDM | EPDM | EPDM | EPDM |
| | Shape | Pulverized | Pulverized | Pulverized | Pulverized | Pulverized |
| Desulfurizing | Type | DPPO | DPPO | DPPO | diethylphosphite | diphenylphosphine |
| agent | Amount [eq] | 5 | 5 | 5 | 10 | 10 |
| Initiator | Amount [eq] | — | — | — | 10 | 10 |
| AIBN | | | | | | |
| Solvent | Type | — | — | — | — | — |
| | Amount [mL] | — | — | — | — | — |
| Reaction | Temperature (° C.) | 160 | 130 | 100 | 160 | 160 |
| conditions | Time [h] | 5 | 5 | 5 | 5 | 5 |
| Properties | Swelling rate [%] | 474 | 336 | 186 | 242 | 820 |
| | Rate of increase | 2.495 | 1.768 | 0.979 | 1.274 | 4.316 |
| | to Sample 1 | | | | | |

TABLE 2

| | | Note | | | |
|---|---|---|---|---|---|
| | | Different amounts of | | Different types of | |
| | | desulfurizing agent, | | desulfurizing agent, | |
| | | without initiator | | without initiator | |
| Sample No. | | 13 | 14 | 15 | 16 |
| Rubber | Type | EPDM | EPDM | EPDM | EPDM |
| | Shape | Pulverized | Pulverized | Pulverized | Pulverized |
| Desulfurizing | Type | DPPO | DPPO | Di-(p-tolyl)phosphine | Diadamantylphosphine |
| agent | | | | oxide | |
| | Amount [eq] | 5 | 2 | 2 | 2 |
| Initiator | Amount [eq] | — | — | — | — |
| AIBN | | | | | |
| Solvent | Type | o-DCB | o-DCB | o-DCB | o-DCB |
| | Amount [mL] | 5 | 5 | 6 | 6 |
| Reaction | Temperature (° C.) | 150 | 150 | 150 | 150 |
| conditions | Time [h] | 5 | 5 | 5 | 5 |
| Properties | Swelling rate [%] | 826 | 853 | 428 | 501 |
| | Rate of increase | 4.347 | 4.489 | 2.253 | 2.637 |
| | to Sample 1 | | | | |

Note
Different types of desulfurizing
agent, without initiator

| Sample No. | | 17 | 18 | 19 |
|---|---|---|---|---|
| Rubber | Type | EPDM | EPDM | EPDM |
| | Shape | Pulverized | Pulverized | Pulverized |
| Desulfurizing | Type | Bis(3,5-dimethylphenyl) | Dicyclohexyl | Di(4-methoxyphenyl) |
| agent | | phosphine oxide | phosphine oxide | phosphine oxide |
| | Amount [eq] | 2 | 2 | 2 |
| Initiator | Amount [eq] | — | — | — |
| AIBN | | | | |
| Solvent | Type | o-DCB | o-DCB | o-DCB |
| | Amount [mL] | 6 | 6 | 6 |
| Reaction | Temperature (° C.) | 150 | 150 | 150 |
| conditions | Time [h] | 5 | 5 | 5 |
| Properties | Swelling rate [%] | 367 | 274 | 467 |
| | Rate of increase | 1.932 | 1.442 | 2.458 |
| | to Sample 1 | | | |

TABLE 3

| | | Note | | | |
|---|---|---|---|---|---|
| | | Different types of solvent | | | |
| Sample No. | | 20 | 21 | 22 | 23 |
| Rubber | Type | EPDM | EPDM | EPDM | EPDM |
| | Shape | Pulverized | Pulverized | Pulverized | Pulverized |
| Desulfurizing | Type | DPPO | DPPO | DPPO | DPPO |
| agent | Amount [eq] | 5 | 5 | 5 | 5 |
| Initiator | Amount [eq] | 2.5 | 2.5 | 2.5 | — |
| AIBN | | | | | |
| Solvent | Type | o-DCB/DMA | o-DCB/DMA | o-DCB/DMA | o-DCB/DMA |
| | | 0.6:0.4 | 0.5:0.5 | 0.4:0.6 | 0.5:0.5 |
| | Amount [mL] | 6 | 6 | 6 | 6 |
| Reaction | Temperature (° C.) | 150 | 150 | 150 | 150 |
| conditions | Time [h] | 5 | 5 | 5 | 5 |
| Properties | Swelling rate [%] | 718 | 968 | 451 | 837 |
| | Rate of increase | 3.779 | 5.095 | 2.374 | 4.405 |
| | to Sample 1 | | | | |

| | | Note | | |
|---|---|---|---|---|
| | | Different types of solvent | | |
| Sample No. | | 24 | 25 | 26 |
| Rubber | Type | EPDM | EPDM | EPDM |
| | Shape | Pulverized | Pulverized | Pulverized |
| Desulfurizing | Type | DPPO | DPPO | DPPO |
| agent | Amount [eq] | 5 | 5 | 5 |
| Initiator | Amount [eq] | — | — | — |
| AIBN | | | | |
| Solvent | Type | o-DCB/1-pentanol | 1-pentanol | DMSO/o-DCB |
| | | 0.5:0.5 | | 1:1 |
| | Amount [mL] | 6 | 6 | 6 |
| Reaction | Temperature (° C.) | 150 | 150 | 150 |
| conditions | Time [h] | 5 | 5 | 5 |
| Properties | Swelling rate [%] | 751 | 284 | 247 |
| | Rate of increase | 3.953 | 1.495 | 1.300 |
| | to Sample 1 | | | |

Sample 1 was sulfur-vulcanized EPDM rubber that has not been desulfurized, which was obtained by kneading 100 phr (parts by mass) of an EPDM polymer (ethylene content: 53.7 mass %, diene content: 9.4 mass %, sulfur component: 0.43 mmol), 5.0 phr of zinc oxide, 1.0 phr of stearic acid, 1.5 phr of sulfur, 1.0 phr of an accelerating agent (TMTD), and 0.5 phr of an accelerating agent (MBT) in an 8-inch roller and then performing press-molding at 160° C. for 20 minutes.

Sample 2 was obtained by reacting the same sulfur-crosslinked EPDM rubber as in Sample 1 using the following methods (1) to (3).
(1) Using a personal organic synthesis device PPS-5511 (EYELA, commercially available from Tokyo Rikakikai Co., Ltd.), 1 g (pulverized product) of sulfur-crosslinked EPDM rubber was put into a reaction container, 12 mL of o-DCB as a solvent was additionally added, and the mixture was left at room temperature for 1 day.
(2) 4 equivalents of DPPO as a desulfurizing agent and 2 equivalents of AIBN as a radical initiator were additionally added to the reaction container, and the mixture was heated at 160° C. for 5 hours. During heating, stirring was continued at a stirring rotation speed of 1,000 rpm using a stirring bar of the same device.
(3) The EPDM rubber was taken out from the reaction container, washed with acetone three times, and then vacuum-dried at 40° C. The above reaction was performed only once.

Sample 3 was obtained by changing the amount of the solvent added in the above (1) and changing the amounts of the desulfurizing agent and radical initiator added in the above (2).

Samples 4 to 7 were obtained by adding no solvent in the above (1), not leaving them at room temperature for 1 day, and increasing the amounts of the desulfurizing agent and radical initiator added in the above (2).

Samples 8 to 10 were obtained by adding no solvent in the above (1), not leaving them at room temperature for 1 day, adding no radical initiator in the above (2), and changing the heating temperature.

Samples 11 and 12 were obtained by adding no solvent in the above (1), not leaving them at room temperature for 1 day, changing the type and addition amount of the desulfurizing agent in the above (2), and changing the amount of the radical initiator added.

Samples 13 and 14 were obtained by changing the amount of the solvent added in the above (1), changing the amount of the desulfurizing agent added in the above (2), and adding no radical initiator.

Samples 15 to 19 were obtained by changing the amount of the solvent added in the above (1), changing the type and addition amount of the desulfurizing agent in the above (2), and adding no radical initiator.

Samples 20 to 26 were obtained by changing the type of the solvent in the above (1), changing the amount of the desulfurizing agent added in the above (2), and changing the amount of the radical initiator added or adding no radical initiator. In Samples 22 to 26, and 28, two types of solvents were used in combination in the volume ratio shown in Table 3.

In Samples 2 to 26, the amount of odor generated during the reaction was small and within the acceptable range, and the amount of odor remaining in the EPDM rubber after the reaction was also small and within the acceptable range.

After the reaction, according to the method described in the section of “<6>Desulfurization index,” the swelling rate of Samples 1 to 26 was determined. In addition, the rate of increase in swelling rate of Samples 2 to 26 to the swelling rate of Sample 1 was calculated. These results are shown in Tables 1 to 3.

In Samples 2 to 9 and 11 to 26, the rates of increase in swelling rate relative to Sample 1 were all 1.10 or more, and desulfurization of the EPDM rubber was observed.

Comparing Samples 2 and 3, desulfurization progressed when the added amounts of the desulfurizing agent and radical initiator increased, and desulfurization did not progress when the amount of the solvent increased.

Comparing Sample 2 (a swelling rate of 421%) and Samples 4 to 7, it was found that desulfurization progressed even when no solvent was added.

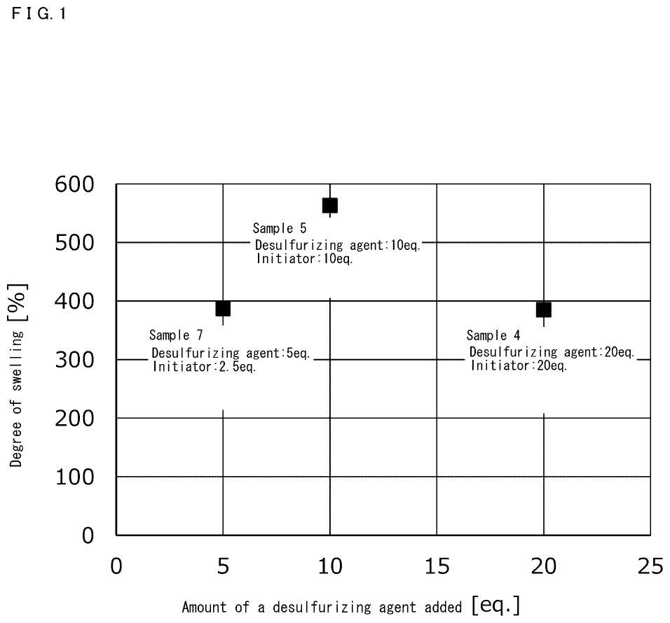

In addition, as shown in FIG. 1, the swelling rate was highest for Sample 5 (10 equivalents of the desulfurizing agent), and the swelling rate was low for Sample 4 (20 equivalents of the desulfurizing agent) and Sample 7 (5 equivalents of the desulfurizing agent). As described above, when no solvent was added, the desulfurizing agent liquefied in the heated reaction system and functioned as a reaction field. This indicates that equivalents (including 8 equivalents to 15 equivalents) of the desulfurizing agent in Sample 5 were an appropriate addition amount (concentration) suitable for forming a reaction field.

Comparing Samples 8 to 10, even when no solvent was added, desulfurization progressed if heating was performed to a predetermined temperature. Since the swelling rate in Sample was low at 0.979, it was considered that a heating temperature of 110° C. or higher was preferable for desulfurization of the EPDM rubber.

As shown in Samples 11 and 12, even when the type of the desulfurizing agent was changed and no solvent was added, desulfurization progressed.

Comparing Samples 3 and 13, progress of desulfurization did not change significantly regardless of whether or not the radical initiator was added.

Comparing Samples 13 and 14, even when the added amount of the desulfurizing agent increased, the progress of desulfurization did not change significantly.

As shown in Samples 11, 12, and 15 to 19, even when the type of the desulfurizing agent was changed, desulfurization progressed.

Comparing Samples 20 to 26, even when the type of the solvent was changed, desulfurization progressed.

Thereby, Samples 2 to 9 and 11 to 26 were considered as examples of the present invention. Sample 10 was a reference example in which the desulfurizing agent in the present invention was used, but heating was not performed at a required temperature.

### Experiment 2

Next, as a desulfurizaton experiment for sulfur-crosslinked natural rubber, Samples 27 to 38 shown in Table 4 below were performed.

TABLE 4

| | | Note | | | | |
|---|---|---|---|---|---|---|
| | | Before | Without initiator, | | | |
| | | desulfurization | different temperatures | | | |
| Sample No. | | 27 | 28 | 29 | 30 | 31 |
| Rubber | Type | NR | NR | NR | NR | NR |
| | Shape | 1 mm | 1 mm | 1 mm | 1 mm | 1 mm |
| | | square | square | square | square | square |
| Desulfurtzing | Type | — | DPPO | DPPO | DPPO | DPPO |
| agent | Amount [eq] | — | 1 | 1 | 1 | 1 |
| Initiator | Amount [eq] | — | — | — | — | — |
| AIBN | | | | | | |
| Solvent | Type | — | DMA | DMA | DMA | DMA |
| | Amount [mL] | | 6 | 6 | 6 | 6 |
| Reaction | Temperature (° C.) | | 70 | 90 | 110 | 130 |
| conditions | Time [h] | | 6 | 4 | 2 | 2 |
| Properties | Swelling rate [%] | 549 | 2357 | 1805 | 1157 | 1355 |
| | Rate of increase | | 4.293 | 3.288 | 2.107 | 2.468 |
| | to Sample 27 | | | | | |

| | | Note | | | | | | |
|---|---|---|---|---|---|---|---|---|
| | | Heat treatment only | | | | | | |
| | | (Different temperatures) | | | Without solvent | | | |
| Sample No. | | 32 | 33 | 34 | 35 | 36 | 37 | 38 |
| Rubber | Type | NR | NR | NR | NR | NR | NR | NR |
| | Shape | 10 mm | 10 mm | 10 mm | 1 mm | 1 mm | 1 mm | 1 mm |
| | | square | square | square | square | square | square | square |
| Desulfurizing | Type | — | — | — | DPPO | DPPO | DPPO | DPPO |
| agent | Amount [eq] | — | — | — | 10 | 10 | 10 | 10 |
| Initiator | Amount [eq] | — | — | — | 5 | 5 | — | — |
| AIBN | | | | | | | | |
| Solvent | Type | DMA | DMA | DMA | — | — | — | — |
| | Amount [mL] | 6 | 6 | 6 | — | — | — | — |
| Reaction | Temperature (° C.) | 90 | 110 | 130 | 70 | 90 | 70 | 90 |
| conditions | Time [h] | 4 | 2 | 2 | 6 | 6 | 6 | 6 |
| Properties | Swelling rate [%] | 759 | 940 | 1161 | 907 | 1455 | 1406 | 1870 |
| | Rate of increase | 1.383 | 1.712 | 2.115 | 1.652 | 2.650 | 2.561 | 3.406 |
| | to Sample 27 | | | | | | | |

Sample 27 was sulfur-vulcanized natural rubber (sulfur component: 0.99 mmol) that has not been desulfurized, which was obtained by kneading 100 phr of natural rubber (SVR—CV60, commercially available from Zao Tian Rubber Company Ltd.), 6.0 phr of zinc oxide, 0.5 phr of stearic acid, 3.5 phr of sulfur, and 0.5 phr of an accelerating agent (MBT) in an 8-inch roller and then performing press-molding at 150° C. for 30 minutes.

Sample 28 was obtained by simply heating the same sulfur-crosslinked natural rubber as in Sample 27 using the following methods (i) to (iii).
(i) Using the personal organic synthesis device, 1 g (1 mm square) of sulfur-crosslinked natural rubber was put into a reaction container, 6 mL of DMA as a solvent was additionally added, and the mixture was left at room temperature for 1 day.
(ii) 1 equivalent of DPPO as a desulfurizing agent was additionally added to the reaction container, and the mixture was heated at 70° C. for 6 hours. During heating, stirring was continued at a stirring rotation speed of 1,000 rpm using a stirring bar of the same device. The reason why the heating temperature was set lower than in Experiment 1 was that the natural rubber had low heat resistance because it had a carbon-carbon double bond in the main chain.
(iii) The natural rubber was taken out from the reaction container, washed with acetone three times, and then vacuum-dried at 40° C. The above treatment was performed only once.

Samples 29 to 31 were obtained by changing the heating temperature and the heating time in the above (ii).

Samples 32 to 34 were obtained by adding no desulfurizing agent in the above (ii), and changing the heating temperature and the heating time in the above (ii). That is, the samples were simply heated and were not desulfurized with a desulfurizing agent.

Samples 35 and 36 were obtained by adding no solvent in the above (i), not leaving them at room temperature for 1 day, increasing the amount of the desulfurizing agent added in the above (ii), and adding a radical initiator.

Samples 37 and 38 were obtained by adding no solvent in the above (i), not leaving them at room temperature for 1 day, and increasing the amount of the desulfurizing agent added in the above (ii).

In Samples 28 to 38, the amount of odor generated during the reaction or during the heat treatment was small and within the acceptable range, and the amount of odor remaining in the natural rubber after the reaction or after the heat treatment was also small and within the acceptable range.

After the reaction or the heat treatment, according to the method described in the section of “<6>Desulfurization index,” the swelling rate of Samples 27 to 38 was determined.

In addition, the rate of increase in swelling rate of Samples 28 to 38 to the swelling rate of Sample 27 was calculated. These results are shown in Table 4.

In Samples 28 to 31 and 35 to 38, the rates of increase in swelling rate relative to Sample 27 were all 1.60 or more, and desulfurization of the natural rubber was observed.

The swelling rate increased in Samples 32 to 34 (simple heat treatment), but this was thought to be due to thermal decomposition caused by heating (as described above, since the natural rubber had low heat resistance), and not due to progress of desulfurization.

Comparing Samples 28 to 31, even if the heating temperature was lower, desulfurization further progressed when the heating time was longer.

Comparing Samples 35 and 36 and Comparing Samples 37 and 38, when the heating time was the same, desulfurization further progressed when the heating temperature was higher.

Comparing Samples 35 and 37 and Comparing Samples 36 and 38, the desulfurization further progressed when no radical initiator was added.

Thereby, Samples 28 to 31, and 35 to 38 were considered as examples of the present invention. Samples 32 to 34 were comparative examples in which no desulfurization reaction occurred.

Based on Experiment 1 and Experiment 2, it was found that the progress of desulfurization can be easily controlled to obtain a desired swelling rate by adjusting factors such as the amount of the desulfurizing agent added, with or without the radical initiator and the amount of the radical initiator added, with or without the solvent and the amount of the solvent added, the heating temperature, and the heating time. For example, it was inferred that when the heating temperature in Sample 10 increased, the rate of increase in swelling rate easily reached 1.10 or more.

In addition, based on the samples corresponding to the examples, it was confirmed that, according to the present invention, a sulfur bond in the sulfur-crosslinked rubber was selectively cleaved and the desulfurization progressed regardless of the rubber type, and deterioration in physical properties was reduced because the main chain of the rubber was not cleaved.

Accordingly, the method of desulfurizing the samples corresponding to the examples can be performed industrially by heating in a large reaction container, a kneader, or a kneading extruder (a twin-screw extruder, etc.), and the desulfurized rubber can be reused as high-quality raw rubber. Particularly, the method can be efficiently performed by heating while kneading in a kneading extruder.

Here, the present invention is not limited to the examples, and can be embodied by being appropriately changed without departing from the spirit and scope of the invention.

1. A method of desulfurizing sulfur-crosslinked rubber, comprising
adding at least one selected from the group consisting of primary and secondary phosphine oxides and analogues of the primary and secondary phosphine oxides, primary and secondary phosphines which become oxides when oxidized and analogues of the primary and secondary phosphines, sulfenic acid, and sulfinic acid as a desulfurizing agent that acts on a sulfur bond in the sulfur-crosslinked rubber and cleaves the sulfur bond to the sulfur-crosslinked rubber, and performing heating.

2. The method of desulfurizing sulfur-crosslinked rubber according to claim 1,
wherein a radical initiator that allows a radical for generating a radical active species from the desulfurizing agent to be generated is also added to the sulfur-crosslinked rubber.

3. The method of desulfurizing sulfur-crosslinked rubber according to claim 1,
wherein no radical initiator that allows a radical for generating a radical active species from the desulfurizing agent to be generated is added to the sulfur-crosslinked rubber.

4. The method of desulfurizing sulfur-crosslinked rubber according to claim 1,
wherein a solvent is also added to the sulfur-crosslinked rubber.

5. The method of desulfurizing sulfur-crosslinked rubber according to claim 1,
wherein no solvent is added to the sulfur-crosslinked rubber.

6. The method of desulfurizing sulfur-crosslinked rubber according to claim 1,
wherein the heating is performed while kneading in a kneading extruder.

7. The method of desulfurizing sulfur-crosslinked rubber according to claim 2,
wherein the heating is performed while kneading in a kneading extruder.

8. The method of desulfurizing sulfur-crosslinked rubber according to claim 3,
wherein the heating is performed while kneading in a kneading extruder.

9. The method of desulfurizing sulfur-crosslinked rubber according to claim 4,
wherein the heating is performed while kneading in a kneading extruder.

10. The method of desulfurizing sulfur-crosslinked rubber according to claim 5,
wherein the heating is performed while kneading in a kneading extruder.
